(19) United States
(12) Patent Application Publication
(10) Pub. No.: US 2003/0148741 A1
(43) Pub. Date: Aug. 7, 2003

(54) Device taking retractable keyboard as activator for answering and hanging up telephone

(75) Inventor: James Chen, Hsinchu (TW)

Correspondence Address: BACON & THOMAS, PLLC, 625 SLATERS LANE, FOURTH FLOOR, ALEXANDRIA, VA, 22314

(73) Assignee: GVC Corporation, Taoyuan Hsien (TW)

(21) Appl. No.: 10/115,024

(22) Filed: Apr. 4, 2002

(30) Foreign Application Priority Data
Feb. 6, 2002 (TW) 091201422

(51) Int. Cl. H04B 1/38

(52) U.S. Cl. 455/90; 455/575

(57) ABSTRACT

A device taking a retractable keyboard as an activator for answering and hanging up a phone, used in a cellular phone with a retractable keyboard. A contact switch is activated after the keyboard of the cellular phone is drawn out, and thereafter, a voltage signal is changed. The changed voltage signal is transmitted into a central processing unit of the cellular phone. The central processing unit judges that this keyboard drawn-out action is a phone answering if a phone call comes in when the contact switch is activated, and commands the cellular phone to make a connection. The contact switch is also activated when the keyboard is pressed back while the phone is connected, the central processing unit judges this pressed-back action is a phone hanging-up, and commands the phone to terminate the connection. Thereby, it is more convenient in the phone answering and hanging-up.

### TECHNICAL FIELD

The present invention relates to a device taking a retractable keyboard as an activator for answering and hanging up a telephone, and more particularly to a retractable keyboard which touches a contact switch to carry out telephone answering and hanging up actions.

### BACKGROUND OF THE INVENTION

A cellular phone with a retractable keyboard is light in weight. But, as to such a kind of telephone, at least two actions must be done when a phone call comes in, one is drawing out the keyboard, and another is pressing a key down to answer the telephone. Therefore, it is very inconvenient, especially when a wrong key is pressed down, a telephone line will be disconnected unexpectedly.

### SUMMARY OF THE INVENTION

The present invention takes a keyboard drawn-out as a telephone answering action, a keyboard pressed-back as a telephone hanging-up action, and these actions can be achieved through the installment of a contact switch.

Accordingly, the main object of the present invention is to provide a device taking a retractable keyboard as an activator for answering and hanging up a telephone, enabling the drawn-out and pressed-back of the keyboard to achieve the effect of answering and hanging-up the telephone, allowing a cellular phone to be more convenient while answering or hanging up the telephone.

The secondary object of the present invention is to provide a device taking a retractable keyboard as an activator for answering and hanging up a telephone, being used for preventing the cellular phone from a disconnection owing to press a wrong key while answering the telephone.

In order to attain the above objects, a contact switch is disposed in a route of the retractable keyboard according to the present invention. The operations of telephone keyboard for answering and hanging-up a telephone are processed respectively by touching the contact switch with the retractable keyboard to change a voltage signal to another voltage signal.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 is a schematic view of a preferred embodiment according to the present invention, showing a state that a keyboard is drawn out;

FIG. 2 is a schematic view of a preferred embodiment according to the present invention, showing a state that a keyboard is pressed back;

FIG. 3 is a schematic view of a preferred embodiment according to the present invention, showing a circuit connection relationship of contact switch of a keyboard and a CPU in a cellular telephone; and

FIG. 4 is a flow chart, illustrating an operation that takes a retractable keyboard as a device for answering and hanging up a telephone.

### DETAILED DESCRIPTION OF THE INVENTION

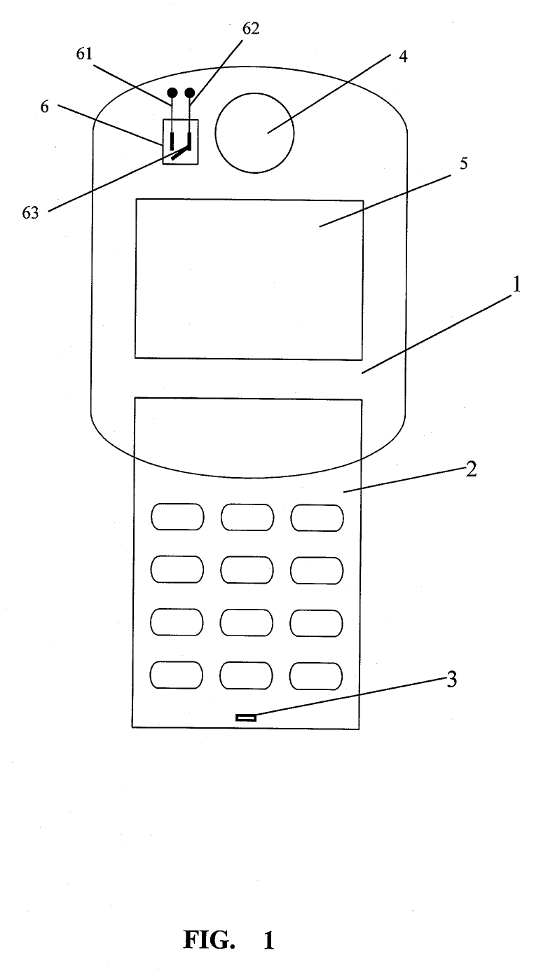

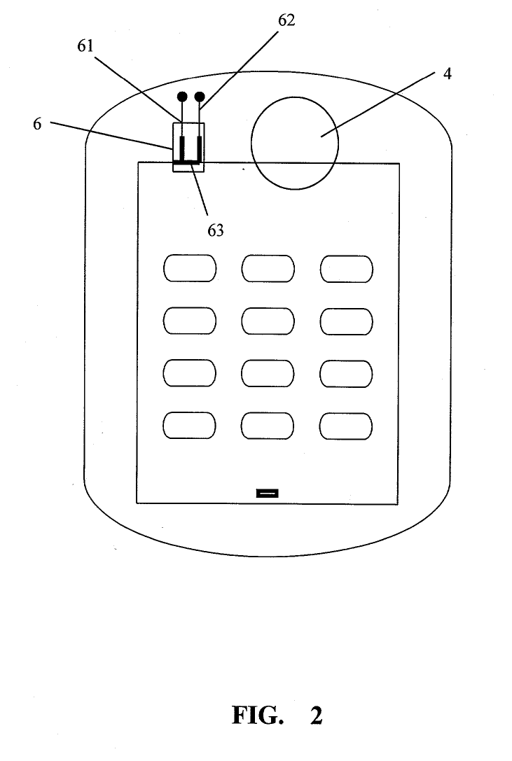

First refer to FIGS. 1 and 2, which shows a cellular phone 1 with a retractable keyboard 2. The cellular phone 1 mainly comprises a retractable keyboard 2, a microphone 3, a speaker 4, a display 5, and a contact switch 6. The retractable keyboard 2 is used for inputting commands. The microphone 3 is used for listening to the telephone. The microphone 4 is used for speaking. The display 5 is used for displaying messages. And the contact switch 6 is touched by the retractable keyboard 2 to answer and hang up the telephone. The contact switch 6 consists of two terminals 61 and 62. One of the two terminals 61 and 62 is connected to a high voltage signal, and another is connected to a CPU. Furthermore, an elastic plate is installed between the two terminals; the elastic plate is fixed and contacts with one of the two terminals 61 and 62, and is formed an open state to another terminal. Therefore, when the retractable keyboard is pressed back to the cellular phone 1, the top end of the retractable keyboard 2 will push the elastic plate 63 to touch another terminal and this will cause the two terminals to form an electrical conduction state. And when the keyboard 2 is drawn out from the cellular phone 1, the elastic plate 63 will be separated form another terminal. A voltage signal will be changed at the moment of the contact and the separation of the elastic plate 63 and the keyboard 2.

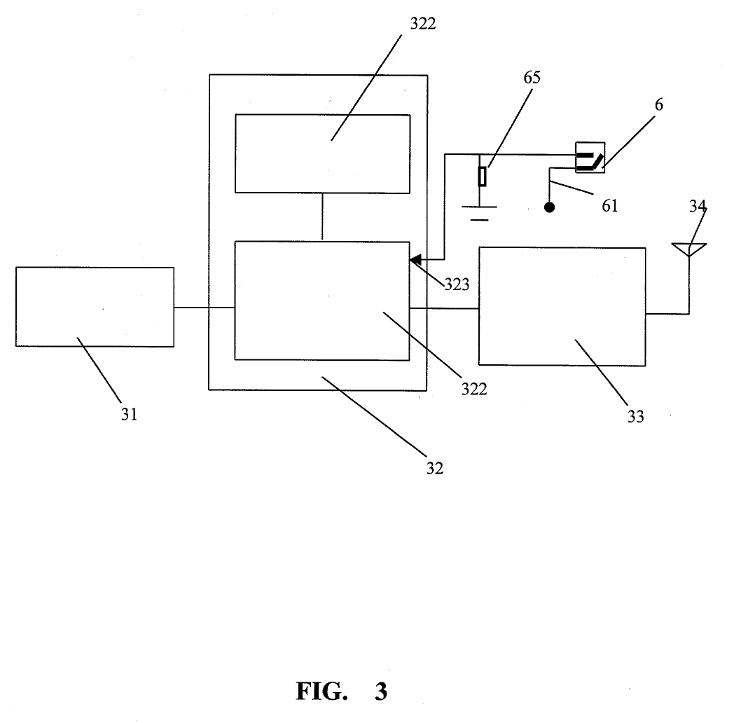

Next, please refer to FIG. 3, which shows a circuit for the contact switch 6 of the keyboard 2 and a CPU 321 of the cellular phone 1. Here, the CPU 321 of a base frequency module 32 is connected to a radio frequency module 33, input/output device 31 and memory 322 of the base module 32. The radio frequency module 33 is further connected with an antenna 34. According to the invention, the CPU 321 is further connected to the contact switch at a signal control input port 323, and a ground resistance 65 is connected between them. The voltage signal is sent into the CPU 321 of the cellular phone 1. If a phone call comes in when the contact switch 6 is touched, the CPU 321 takes this drawing out action of the keyboard 2 as the telephone answering, and then a telephone line is connected immediately. If the keyboard 2 is pressed back in the middle of a communication, as FIG. 2 shows, the voltage signal will also be changed, then the CPU will take this pressing back action as an operation of a telephone hanging-up, the communication will disconnect immediately.

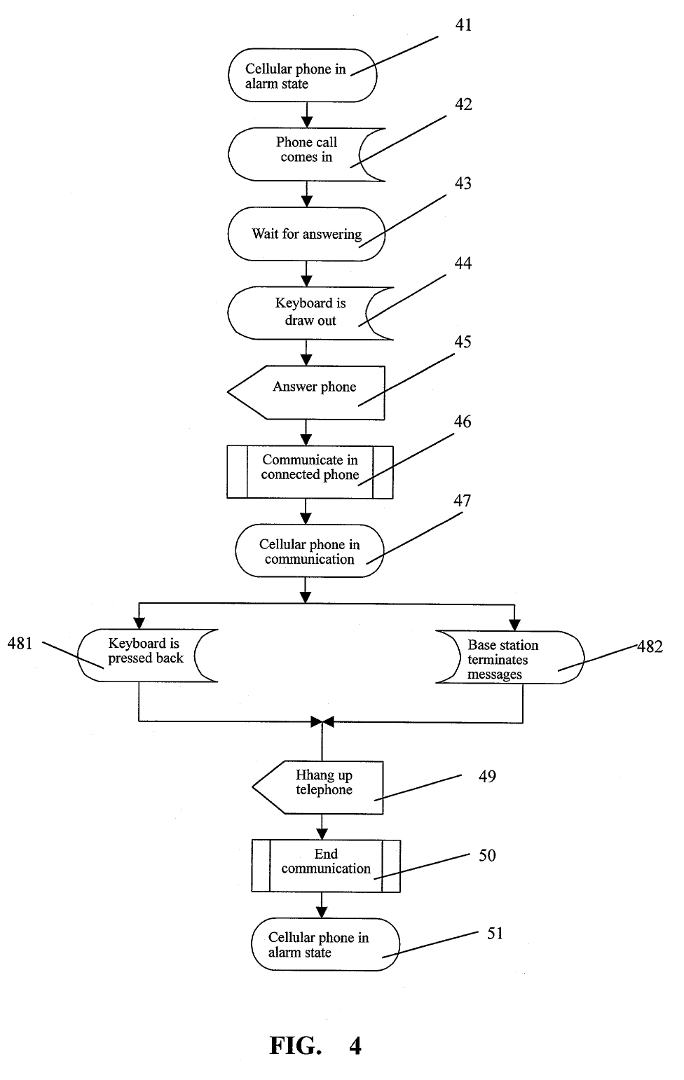

FIG. 4 shows an operation flow chart that the retractable keyboard is used as a device for answering or hanging up a telephone. First, the cellular phone is on and in an alarm state (step 41), a phone call comes in (step 42). The cellular phone sounds a warning or musical ring, then waits for an answering (step 43). At that time, a user draws out the keyboard (step 44) to answer the telephone (step 45). Thereafter, the user processes a communication in the connected telephone (step 46), and then the cellular phone is in a communication status (step 47). If the user presses the keyboard back (step 481) or a cellular phone base station terminates messages (step 482) at that time, the CPU will receive a voltage signal and then command the cellular phone to hang up the telephone (step 49) then stop the telephone communication (step 50), and the cellular phone will be in the alarm state again (step 51).

A cellular phone with a retractable keyboard generally needs two steps to answer a telephone. However, a device according to the present invention takes drawing out a keyboard as answering a telephone, and pressing back the keyboard as hanging up the telephone. A device that has the same structure and purpose as the device according to the invention is not yet found until now. Besides, it is convenient for a user to answer or to hang up a telephone.

It is noted that the retractable keyboard in a device used for answering and hanging up a telephone described above is the preferred embodiment of the present invention for the purpose of illustration only, and are not intended as a definition of the limits and scope of the invention disclosed. Any modifications and variations that may be apparent to a person skilled in the art are intended to be included within the scope of the present invention.

What is claimed is:

1. A device taking a retractable keyboard as an activator for answering and hanging up a telephone, comprising a retractable keyboard and contact switch, wherein said contact switch is installed in a route along which a retractable keyboard of a cellular phone is drawn out and pressed back; said contact switch being untouched to process an action for answering a telephone when said keyboard of said cellular phone is drawn out and said contact switch being touched to process an action for hanging up a telephone when said keyboard of said cellular phone is pressed back.

2. The device according to claim 1, wherein a voltage signal is changed after said contact switch is activated.

3. The device according to claim 2, wherein said voltage signal is sent into a CPU of said cellular telephone.

4. The device according to claim 3, wherein said telephone is connected after said CPU receives said voltage signal when said contact switch is activated (untouched) and a phone call comes in.

5. The device according to claim 3, wherein said telephone is hanged up after said CPU receives said voltage signal when said keyboard is pressed back and said contact switch is activated (touched).

6. The device according to claim 1 or 5, wherein said CPU also can process said hanging-up action of said telephone when said base station terminates a messages delivery.

7. The device according to claim 1, 4 or 5, wherein said contact switch can be a keyboard type contact switch, one of two terminals of said contact switch is connected to a high voltage signal source, and another is connected to said CPU.

8. The device according to claim 7, wherein an elastic plate used for disconnecting and conducting electricity is further disposed at said contact switch, only one end of said elastic plate is fixed to and contacts with one of said two terminals of said contact switch.

9. The device according to claim 8, wherein another end of said elastic plate separates from another terminal and said voltage signal is changed when said keyboard is drawn out.

10. The device according to claim 8, wherein another end of said elastic plate touches another terminal and said voltage signal is changed when said keyboard is pressed back.

11. The device according to claim 1, said contact switch is installed at the end of said route.
